(19) United States
(12) Patent Application Publication
(10) Pub. No.: US 2019/0057311 A1
(43) Pub. Date: Feb. 21, 2019

(54) WEATHER AND EXPERIENCE SYMBIOSIS WITH RESPECT TO PRINCIPAL PERFORMANCE

(71) Applicant: International Business Machines Corporation, Armonk, NY (US)

(72) Inventors: John C. Newell, Austin, TX (US); Aaron K. Baughman, Silver Spring, MD (US); Craig M. Trim, Sylmar, CA (US); Victor Povar, Vancouver (CA)

(21) Appl. No.: 15/677,120

(22) Filed: Aug. 15, 2017

(51) Int. Cl. G06N 5/02; G06N 99/00

(52) U.S. Cl. CPC G06N 5/022; G06N 99/005

(57) ABSTRACT

Machine logic that uses weather data and play style of players to predict outcomes of sporting contests. These predicted outcomes can be used for various purposes such as sporting contest scheduling, or controlling of play conditions. Also, machine logic to agglomerate data from various players together to increase data purity and/or learn from observed data (for example, learn from outcomes of training matches).

### BACKGROUND

The present invention relates generally to the field of using machine logic (for example, computer software) to predict outcomes (see definition of “outcomes,” below, in Definitions sub-section, below) in sporting contests (see definition of “sporting contests,” below, in Definitions sub-section), and more particularly to machine logic for predicting outcomes of tennis matches.

It is known to use computer software to predict likely outcomes of sporting contests by applying machine logic based rules, based upon historical data and/or contest-in-progress data, to data relevant to an upcoming, or in-progress, sporting contest. For example, US patent publication number 2016/0310850 states as follows: “The historical data source . . . can generally include data from one or more databases or other sources that is relevant to outcome predictions for the type of game being analyzed. For example, for a baseball prediction implementation, the historical data source . . . can include one or more databases storing baseball historical data, such as for example player and action outcomes for batters and pitchers with relevant situational information (e.g., the count, number of baserunners and/or outs, current score, inning, other game situation data, specific batter vs. specific hitter outcomes, umpire characteristics, weather, ballpark characteristics, etc.). In a soccer example, the historical data source . . . can include one or more databases storing soccer historical data, such as for example player and action outcomes for players at different positions with relevant situational information (e.g., remaining game time, weather conditions, type of defense being played, outcomes against similar opposing teams or players, outcomes against a given goalie or goalies with similar styles or other characteristics, referee characteristics, current score, etc.).” It is noted that the types of input data in the foregoing example includes both weather data and data on “goalies with similar styles.”

### SUMMARY

According to an aspect of the present invention, there is a method, computer program product and/or system that performs the following operations (not necessarily in the following order): (i) receiving a set of machine logic based rules that are programmed to predict outcomes of sporting contests based, at least in part, upon both of the following factors: weather of the sporting contests and play styles of players of the sporting contests; (ii) receiving a first sporting contest data set including information related to a first sporting contest including: play styles of players that are playing, or proposed to play, in the first sporting contest and weather occurring, or forecasted for, the first sporting contest; (iii) applying the set of machine logic rules to the first sporting contest data set to obtain a first predicted outcome; and (iv) controlling a play condition of the first sporting contest based, at least in part, upon the first predicted outcome.

According to an aspect of the present invention, there is a method, computer program product and/or system that performs the following operations (not necessarily in the following order): (i) receiving a set of machine logic based rules that are programmed to schedule sporting contests based, at least in part, upon both of the following factors: weather of a set of to-be-scheduled sporting contests and play styles of players of the set of to-be-scheduled sporting contests; (ii) receiving a first sporting contest data set including information related to the set of to-be-scheduled sporting contest including: play styles of players that are proposed to play in the set of proposed sporting contests and weather forecasted for time period and potential locations at which the set of proposed sporting contests may occur; (iii) applying the set of machine logic rules to potential sporting contests in accordance with the set of to-be-scheduled sporting contests; and (iv) scheduling the to-be-scheduled sporting contests to generate a set of scheduled contests, with the scheduling determining at least identities of the players to play in the scheduled contests.

According to an aspect of the present invention, there is a method, computer program product and/or system that performs the following operations (not necessarily in the following order): (i) agglomerating players together to increase data purity; (ii) receiving historical data related to historical sporting contest outcomes, play styles of players involved in the historical sporting contests and weather in which the historical sporting contests were conducted; and (iii) generating, by machine logic and based upon the historical data, a set of machine logic rules, programmed to predict outcomes of sporting contests based, at least in part, upon both of the following factors: weather of the sporting contests and play styles of players of the sporting contests.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4A is a screenshot view generated by the first embodiment system;

FIG. 4B is another screenshot view generated by the first embodiment system;

FIG. 5 is a graph of data of the type used by some embodiments of the present invention;

FIG. 6 is a graph of data of the type used by some embodiments of the present invention;

FIG. 7 is a diagram of an embodiment of rule generation according to the present invention;

FIG. 8 is a screenshot view of a table of data generated by an embodiment of the present invention; and

FIG. 9 is screenshot view of another table of data generated by an embodiment of the present invention.

### DETAILED DESCRIPTION

Some embodiments of the present invention use weather (see definition, below) data and play style (see definition, below) to predict outcomes (see definition, below) of sporting contests (see definition, below). These predicted outcomes can be used for various purposes such as sporting contest scheduling (see definition, below), or controlling of play conditions (for example, closing a stadium roof). Some embodiments agglomerate data from various players (see definition, below) together to increase data purity and/or learn from observed data (for example, learn from outcomes of training matches). This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

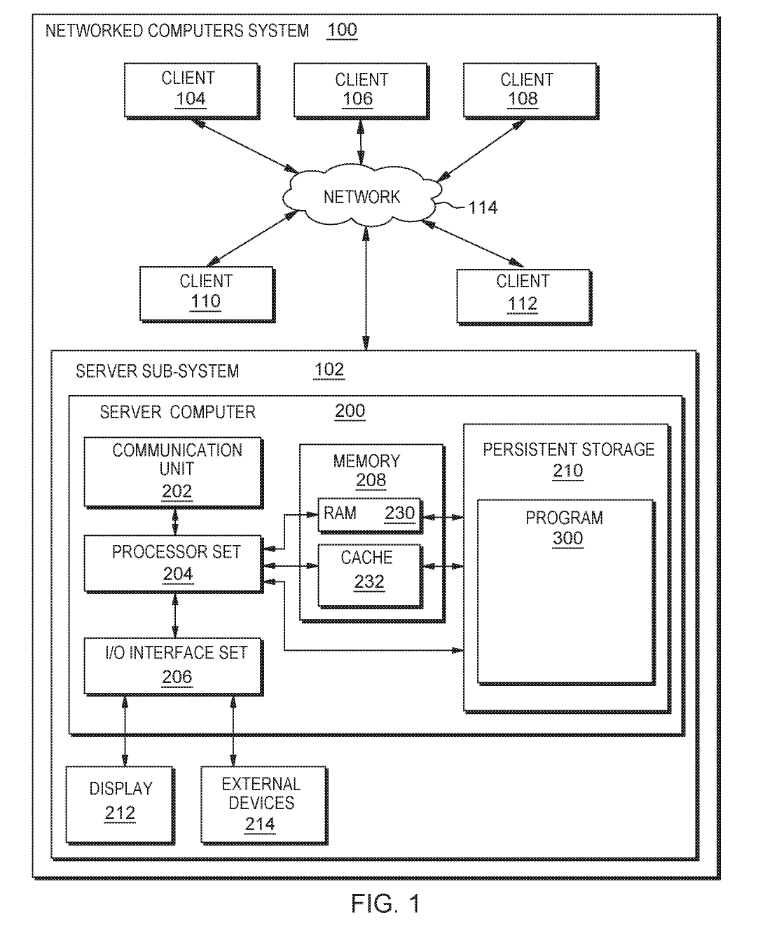

An embodiment of a possible hardware and software environment for software and/or methods according to the present invention will now be described in detail with reference to the Figures. FIG. 1 is a functional block diagram illustrating various portions of networked computers system 100, including: server sub-system 102; client sub-systems 104, 106, 108, 110, 112; communication network 114; computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments, the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

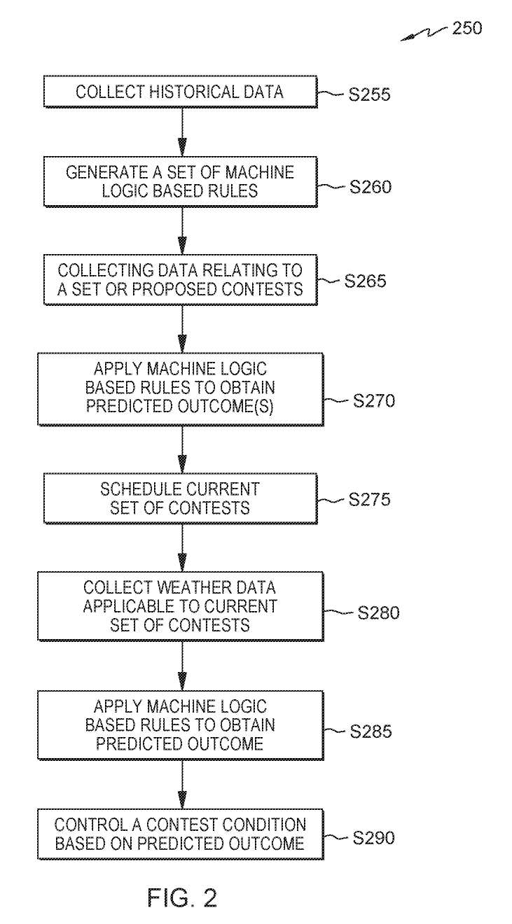

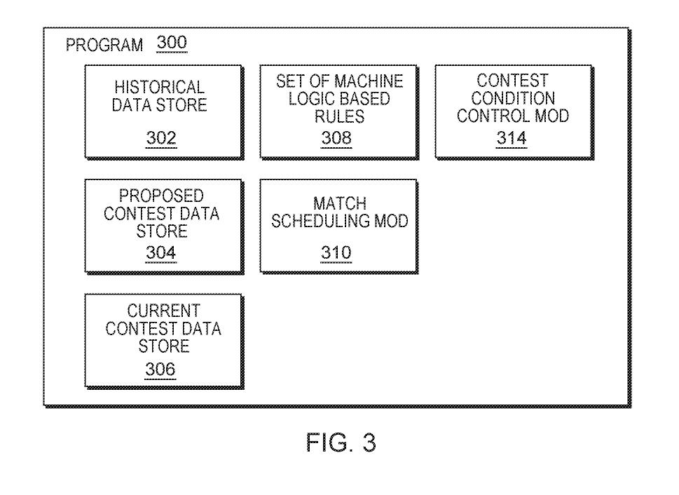

FIG. 2 shows flowchart 250 depicting a method according to the present invention. FIG. 3 shows program 300 for performing at least some of the method operations of flowchart 250. This method and associated software will now be discussed, over the course of the following paragraphs, with extensive reference to FIG. 2 (for the method operation blocks) and FIG. 3 (for the software blocks).

Processing begins at operation S255, where historical data store 302 of program 300 collects three (3) types of historical data as follows: (i) data related to win/loss outcomes, players, dates and locations of tennis match sporting contests that have already been played (from a tennis archive on client sub-system 104 (see FIG. 1)); (ii) play style respectively corresponding to the players involved in the historical tennis matches of the previous item (from a sports experts database on client sub-system 106 (see FIG. 1)); and (iii) weather data corresponding to the dates and locations of the historical tennis matches of the first item on this list. While this embodiment uses expert evaluations to determine play style (see definition, below) of various players, other embodiments may use clustering algorithms, as will be further discussed, below, in the next sub-section.

Processing proceeds to operation S260 where a set of machine logic based rules 308 are generated correlations observed in the historical data collected at operation S255. These machine logic based rules are designed to predict an outcome of a tennis match based, at least in part, upon the following two factors: (i) play style of the players involved; and (ii) predicted weather. In this embodiment, there are four play styles as follows: (i) net slasher, (ii) epic rallier, (iii) power server, and (iv) baseline sitter. In this embodiment, each player is designated with only one of these four styles. Alternatively, multiple styles could be associated with a player (for example, one style for offensive play and another style for defensive play.

Processing proceeds to operation S265 where proposed contest data store 304 collects data related to a set of proposed contests. In this example, designed to show how certain aspects of the present invention may operate in a hypothetical manner, this set of proposed contests are the semi-final tennis matches of a hypothetical tennis tournament called the Extreme Tennis Tournament (ETT). The semifinalists are as follows: (i) Jane Netslasher (play style=net slasher); (ii) Greta Powerserver (play style=power server); (iii) Julie Baselinesitter (play style=baseline sitter); and (iv) Gertrude Epicrally (play style=epic rallier).

Before proceeding to the manner in which program 300 schedules these ETT semi-final matches, a few operating precepts of the hypothetical ETT will be described: (i) players will, at least sometimes, play in adverse weather conditions (such as weather conditions so adverse that they would cause a suspension of play in more standard tennis tournaments); (ii) artificial weather conditions, such as artificial fog, artificial mist style precipitation, humidity control and artificial wind may be used under the control of ETT authority; (iii) match pairings in the tournament will be selected to obtain the most “even” matches (as taken in the aggregate) for each round of the tournament; (iv) cities and venues of the tournament will be scheduled, where possible, to benefit the less favored participant in the match (for example, if the less favored player plays better in the snow than a more favored opponent then match might be scheduled to take place in a snowy city); and (v) the artificial weather components, mentioned above, will be controlled by ETT authority to keep matches as even as possible as they progress (for example, if a player is losing at mid-game, then the wind machines might be adjusted so that the wind is blowing in a favorable direction for her).

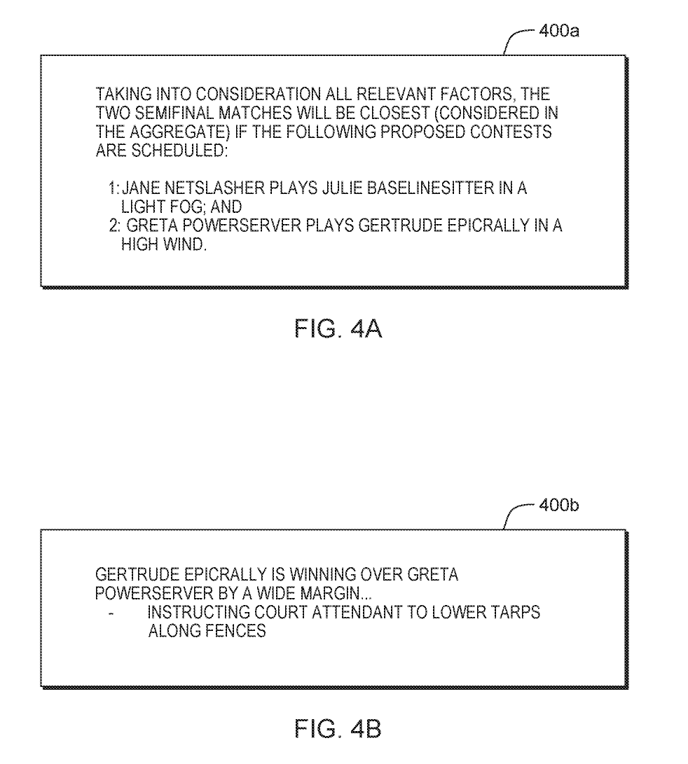

Processing proceeds to operation S270, where match scheduling mod 310 applies set of machine logic based rules 308 predict outcomes of various hypothetical pairings of the four semi-finalists mentioned above in various hypothetical weather conditions. Screenshot 400a of FIG. 4A shows the closest predicted win/loss outcomes of these hypothetical matches among and between the four named players.

Processing proceeds to operation S275 where match scheduling mod 310 schedules the current set of contests, including: (i) determining that Jane Netslasher will play Julie Baselinesitter in the semi-finals; (ii) determining that Greta Powerserver will play Gertrude Epicrally in the semi-finals; (iii) scheduling the Netslasher/Baselinesitter match to determine that it will be played in a foggy city, in a stadium located in a fog zone (and equipped with fog machines) and at a time of day when fog is likely; and (iv) scheduling the Powerserver/Epicrally match in a windy city on a tennis court in an open field on a day when high winds are predicted in the weather forecast. Because this scheduling is based, at least in part, on the hypothetical outcomes predicted by the machine logic rules, the scheduling is therefore based, at least in part, upon the play styles of the players and weather conditions (in this case, predicted weather conditions). As indicated by screenshot 400a, this scheduling is performed in an attempt to make the two matches of the ETT semi-finals as close as possible, which is a publically understood (and widely beloved) precept of the ETT. The scheduling is based upon weather, rather than more traditional concepts like seed, but it is guided by transparent guidelines and is not arbitrary.

Processing proceeds to operation S280 which is performed at the halfway point of each of the semi-final matches. In operation S280, current contest data store 306 collects from client sub-system 110 (see FIG. 1) current weather conditions of the semi-final match, and score of the semi-final match.

Processing proceeds to operation S285 where set of machine logic based rules predicts the outcome of the match that is underway. This prediction will be based upon current weather and scoring data, which will likely make the prediction different, and more accurate than, the pre-match prediction that occurred back at the scheduling phase in operation S275.

Processing proceeds to operation S290, where contest condition control mod 314 automatically, or with human assistance, controls the play conditions to make the match closer. In the Epicrally/Powerserver match, Powerserver was initially favored to win. This is part of the reason that the match was scheduled for a high wind location—the wind favors Epicrally's play style, and the ETT wants to keep matches as even as possible. However, against expectations, Epicrally is winning. Therefore, as shown in screenshot 400b of FIG. 4B, mod 314 instructs the court attendant to lower the tarps along the fence around the court where the Epicrally/Powerserver match is taking place. This reduces the wind, which helps Powerserver's game in order to make the second half of the match closer than the first half was. The live streaming match audience is duly enthralled and keeps watching right to the end of the match (although it will not be revealed here who won).

At operation S290 in the Netslasher/Baselinesitter match mod 314 gets the fog machine going because the hoped-for natural fog never materialized and the match is going for the more favored player at the halfway point.

The kind of control exercised, or recommended, by mod 314 is herein generically referred to as play condition control. In various embodiments of the present invention, play condition control may, without limitation, include the following types of control: opening closing a retractable stadium roof, adjusting air pressure in a stadium, adjusting oxygen level in a play space, opening closing a play space to natural wind, generating artificial wind/snow/rain/fog, etc., adjusting humidity in a play space and/or adjusting temperature in a play space.

### III. Further Comments and/or Embodiments

Some embodiments of the present invention recognize the following facts, potential problems and/or potential areas for improvement with respect to the current state of the art: (i) weather conditions have a significant impact on how certain sports, such as tennis, played by various players; (ii) the impact of weather on sports has primarily been experienced and understood firsthand, so fans and spectators haven't been able to fully appreciate the impact of weather conditions on the gameplay and resultant outcomes; and/or (iii) players are affected by changes in wind speed, humidity, air pressure, and especially temperature as they play sports (for example, tennis), and understanding the impact of weather conditions on various players would greatly improve the fan experience.

Some embodiments of the present invention may include one, or more, of the following features, characteristics, operations and/or advantages: (i) player profiles are created based on playing style over a large number of dimensions so that weather impact, or keys, can be assessed on player styles and extrapolated to players who have yet to play in those conditions; (ii) fan(s) can explore these effects through mobile devices, web interfaces, and immersive environments that bring the weather conditions to life; (iii) weather impact keys will also be used for training purposes, as players and tournament organizers can assess weather conditions and schedule matches and practices accordingly; (iv) physical objects can change based on generating a close match or during bracket creation (this should only be done in a responsible, and transparent, manner with due regard for the ethical conventions of the sport involved, as discussed above); (v) tournaments are based, not solely on seed, but also on forecasted play and the pairings of players that will have the closest matches (this should only be done in a responsible, and transparent, manner with due regard for the ethical conventions of the sport involved, as discussed above); and/or (vi) the physical conditions of play are altered to increase a closer match such as closing a dome or turning on humidifiers or increasing heat (this should only be done in a responsible, and transparent, manner with due regard for the ethical conventions of the sport involved, as discussed above).

Some embodiments of the present invention may include one, or more, of the following features, characteristics, operations and/or advantages: (i) weather based keys to the match utilize millions of data points from large database(s) of historical weather data to evaluate the weather conditions at tennis tournaments over the past years and determine how they impact the play of players and player styles; (ii) leverages the existing analysis within currently conventional sports outcome predicting software to identify playing styles across over 50 dimensions of point, execution, location, and tactical dimensions; (iii) weather keys identify and quantify the impact of certain weather conditions and combination of conditions on player styles and individual players; (iv) these keys are used to increase understanding of what influences the game of tennis and the outcomes of certain matches; and/or (v) the weather keys are used as aids to tournament organizers who have to schedule around these weather conditions and players who will want to train to improve in certain weather conditions.

Some embodiments of the present invention may include one, or more, of the following features, characteristics, operations and/or advantages: (i) the weather keys leverage pre-existing cross platform application(s) that provide real-time scores, statistics and insights for all matches in progress; (ii) allows tennis fans an unprecedented level of analysis, insight and engagement as the match unfolds, especially through fans' mobile devices; (iii) hones the data and insight in pre-existing sporting contest outcome predictive software with ball and player position data and insights based on pressure situations; and/or (iv) these insights will show the historical performance for a player when in the specific situation, revealing hidden patterns in player and match dynamics.

Some embodiments of the present invention may include one, or more, of the following features, characteristics, operations and/or advantages: (i) includes a feature built on predictive analytics technology that analyzes eight (8) years of certain tennis tournament data (for example, 41 million data points) to identify the three (3) key performance objectives for each player based on patterns in the data and previous match-ups; (ii) quantifies previously unknown relationships between player outcomes, ball position and individual weather conditions; (iii) leverages player style analysis to extrapolate weather impacts on players of similar and differing playing styles; (iv) leverages positional and velocity data to identify the impact of weather conditions on individual shot types; (v) symbiosis between weather keys and an environment; (vi) symbiosis between weather keys and a mobile device; and/or (vii) weather keys used for practice temporal scheduling; and/or (viii) weather keys used for practice place scheduling.

Some exemplary code is as follows:

Sys.setenv(JAVA_HOME=′/Library/Java/JavaVirtualMachines/1.6.0.jd
k/Contents/Home′)
Sys.setenv(LD_LIBRARY_PATH = ′$LD_LIBRARY_PATH:SJAVA_
HOME/lib′)
#Install rJava with java 1.6
install.packages(″rJava″, type = ″source″)
#load jdbc
library(RJDBC)
#Setup the database connection
drv <-
JDBC(′com.ibm.db2.jcc.DB2Driver′,′/Applications/dsdriver/java/db
2jcc.jar′,identifier.quote=″′″)
ch <-dbConnect(drv,′jdbc:db2://dashdb-entry-yp-da109-
10.services.dal.bluemix.net:50000/BLUDB:user=dash11185;password=
e6dc669ed3d6′)
#Get the weather data
allWeather <- dbGetQuery(ch, ″select player_1a_id as player_id,
court_name, prestige, case when winner=1 then 1 else 0 end as
state,a.year,a.tournament,completion_time,b.feels_like_avg,b.gus
t_avg,b.heat_index_avg,b.pressure_avg,b.temp_avg,b.humidity_avg,
b.precipitation_hourly_sum,c.weather_station_latitude,c.weather_
station_longitude from matches a right join event_weather b on
(a.tournament=b.event_name and
DAY(a.completion_time)=DAY(b.reading_date) and
MONTH(a.completion_time)=MONTH(b.reading_date) and
YEAR(a.completion_time)=YEAR(b.reading_date)) left join
event_weather_location c on c.event_name=a.tournament left join
courts on a.court_id=courts.court_id union select player_2a_id
as player_id, court_name, prestige, case when winner=2 then 1
else 0 end as
state,a.year,a.tournament,completion_time,b.feels_like_avg,b.gus
t_avg,b.heat_index_avg,b.pressure_avg,b.temp_avg,b.humidity_avg,
b.precipitation_hourly_sum,c.weather_station_latitude,c.weather_
station_longitude from matches a right join event_weather b on
(a.tournament=b.event_name and
DAY(a.completion_time) =DAY(b.reading_date) and
MONTH(a.completion_time) =MONTH(b.reading_date) and
YEAR(a.completion_time) =YEAR(b.reading_date)) left join
event_weather_location c on c.event_name=a.tournament left join
courts on a.court_id=courts.court_id″)
#Get the keys to the match data
ch2 <-dbConnect(drv,′jdbc:db2://events-
stage.atl.dst.ibm.com:50000/SLAMS:user=score;password=un4cederr′
)
playerStyles <- dbGetQuery(ch2, ″select * from
model_game_styles″)
#merge the player style and weather data frames together with
right outer join
mergedData <-
merge(x=allWeather,y=playerStyles,by=″PLAYER_ID″,all.y=TRUE)
#explore data
#correlation matrix
cor(mergedData[sapply(mergedData,is.numeric)])
#create correlation matrix for each player type
mcluster1<-mergedData[mergedData$GAME_STYLE_ID==″ms-cluster-1″,]
cor(mcluster1[sapply(mcluster1,is.numeric)])
mcluster2<-mergedData[mergedData$GAME_STYLE_ID==″ms-cluster-2″,]
cor(mcluster2[sapply(mcluster2,is.numeric)])
mcluster3<-mergedData[mergedData$GAME_STYLE_ID==″ms-cluster-3″,]
cor(mcluster3[sapply(mcluster3,is.numeric)])
mcluster4<-mergedData[mergedData$GAME_STYLE_ID==″ms-cluster-4″,]
cor(mcluster4[sapply(mcluster4,is.numeric)])
mcluster5<-mergedData[mergedData$GAME_STYLE_ID==″ms-cluster-5″,]
cor(mcluster5[sapply(mcluster5,is.numeric)])
#plot correlation to matches won for men
df<-data.frame(1,−0.0275,−0.0275,0.018,−0.028,−0.0049)
names(df)<-
c(′player_ability′,′feels like′,′heat index′,′pressure′,′tempera
ture′,′humidity′)
df<-rbind(df,c(2,−0.018,−0.0187,0.009,−0.018,0.0132))
df<-rbind(df,c(3,−0.0259,−0.0252,−0.006,−0.0253,0.0118))
df<-rbind(df,c(4,0.005,0.0058,−0.0178,−0.00579,−0.0225))
df<-rbind(df,c(5,0.0276,0.028,0.0228,0.0293,−0.0519))
barplot(df$feels_like,names=df$player_ability,xlab=′Player
Ability′,ylab=′Player Correlation′,main=′Weather Effects on
Play′)
barplot(t(as.matrix(df[2:6])),col=c(″darkblue″,″red″,″green″,″or
ange″,″purple″),names=df$player_ability,beside=TRUE,legend=colna
mes(df[2:6]),args.legend=list(x=25,bty=″n″,y=−
0.023),xlab=′Player Type′,ylab=″Correlation″,main=″Weather
Effects on Men′s Single Play″)
#plot covariance to matches won for men
df<-data.frame(1,−0.123,−0.124,0.085,−0.123,−0.032)
names(df)<-
c(′player_ability′,′feels_like′,′heat_index′,′pressure′,′tempera
ture′,′humidity′)
df<-rbind(df,c(2,−0.08,−0.08,0.04,−0.07,0.08))
df<-rbind(df,c(3,−0.11,−0.11,−0.03,−0.11,0.07))
df<-rbind(df,c(4,0.02,0.02,−0.08,0.02,0.13))
df<-rbind(df,c(5,0.11,0.11,0.1,0.12,0.32))
barplot(t(as.matrix(df[2:6])),col=c(″darkblue″,″red″,″green″,″or
ange″,″purple″),names=df$player_ability,beside=TRUE,legend=colna
mes(df[2:6]),args.legend=list(x=15,bty=″n″,y=0.3),xlab=′Player
Type′,ylab=″Covariance″,main=″Weather Effects on Men′s Single
Play″)
#plot correlation to matches won for women
dfw<-data.frame(1,−0.011,−0.011,0.0105,−0.011,−0.02)
names(dfw)<-
c(′player_ability′,′feels_like′,′heat_index′,′pressure′,′tempera
ture′,′humidity′)
dfw<-rbind(dfw,c(2,−0.0538,−0.0534,−0.0389,−0.0544,0.008))
dfw<-rbind(dfw,c(3,−0.048,−0.046,0.0001,−0.0517,0.0144))
dfw<-rbind(dfw,c(4,−0.03,−0.0314,−0.02,−0.0369,0.018))
dfw<-rbind(dfw,c(5,−0.0192,−0.0196,0.0019,−0.0196,0.0294))
dfw<-rbind(dfw,c(6,0.0211,0.0213,0.001,0.0233,−0.037))
barplot(t(as.matrix(dfw[2:6])),col=c(″darkblue″,″red″,″green″,″o
range″,″purple″),names=dfw$player_ability,beside=TRUE,legend=col
names(dfw[2:6]),args.legend=list(x=32,bty=″n″,y=−
0.025),xlab=′Player Type′,ylab=″Correlation″,main=″Weather
Effects on Women′s Single Play″)
#plot covariance matrix to matches won for women
dfw<-data.frame(1,−0.05,−0.05,0.04,−0.04,−0.13)
names(dfw) <-
c(′player_ability′,′feels_like′,′heat_index′,′pressure′,′tempera
ture′,′humidity′)
dfw<-rbind(dfw,c(2,−0.23,−0.22,−0.18,−0.23,0.05))
dfw<-rbind(dfw,c(3,−0.22,−0.21,0,−0.23,0.09))
dfw<-rbind(dfw,c(4,−0.14,−0.15,−0.1,−0.17,0.13))
dfw<-rbind(dfw,c(5,−0.08,−0.09,0,−0.08,0.19))
dfw<-rbind(dfw,c(6,0.09,0.09,0,0.1,−0.24))
barplot(t(as.matrix(dfw[2:6])),col=c(″darkblue″,″red″,″green″,″o
range″,″purple″),names=dfw$player_ability,beside=TRUE,legend=col
names(dfw[2:6]),args.legend=list(x=15,bty=″n″,y=0.25),xlab=′Play
er Type′,ylab=″Covariance″,main=″Weather Effects on Women′s
Single Play″)
#Logistic Regression
#Create test and train data
mens<-mergedData[grep(″ms″,mergedData$GAME_STYLE_ID),]
smp size<-floor(0.75*nrow(mens))
set.seed(123)
mens_train_ind<-sample(seq_len(nrow(mens)),size=smp_size)
mens_train<-mens[mens_train_ind,]
mens_test<-mens[-mens_train_ind,]
#train model
glm.fit=glm(STATE~FEELS_LIKE_AVG+HEAT_INDEX_AVG+
PRESSURE_AVG+TEM
P_AVG+HUMIDITY_AVG,data=mens_train,family=″binomial″)
summary(glm.fit)
(Intercept) 1.2631465 0.9608470 1.315 0.188638
FEELS_LIKE_AVG −0.1063954 0.0432194 -2.462 0.013826 *
HEAT_INDEX_AVG 0.1536279 0.0444985 3.452 0.000556 ***
PRESSURE_AVG −0.0007055 0.0009293 −0.759 0.447753
TEMP_AVG −0.0508001 0.0206529 -2.460 0.013905 *
HUMIDITY_AVG −0.0031082 0.0009469 -3.283 0.001029 **
#test model
pred=predict(glm.fit,newdata=mens test,type=″response″)
mens_test[,″STATE″]
table(pred,mens_test[,″STATE″])
prediction=rep(0,17939)
prediction[pred>0.5]=1
table(prediction,mens_test[,″STATE″])
prediction 0 1
1 8413 9526
#get accuracy
accuracy<-table(prediction,mens_test[,″STATE″])
sum(diag(accuracy))/sum(accuracy)
0.4689782

Some embodiments of the present invention may include one, or more, of the following features, characteristics, operations and/or advantages: (i) sorting players (for example, tennis players, golfers) of a particular sporting event (for example, tennis tournament) into multiple play-style categories (for example, aggressive, backhand dominant, etc.); (ii) determining how aspects of weather conditions (for example, rain, humidity, temperature) differentially effect each play-style category (for example, aggressive players play 10% worse in heat); (iii) forecasting the weather at the particular sporting event; (iv) predicting, based on the weather forecast and their respective play-styles, how each player will perform at the event; (v) using the predicted player performances to predict the outcomes of particular matches at the particular sporting event; (vi) modifying, based on the predicted performances, the conditions at the event—for example, move dome into place in order improve performance of most players (this should only be done in a responsible, and transparent, manner with due regard for the ethical conventions of the sport involved); (vii) monitoring, at the sporting event, the current weather conditions; and/or (viii) generating, based on the current weather conditions, their respective play-styles, and the respective play-styles of their opponents, location-based recommendations for shots within the field of play for each player.

Some embodiments of the present invention may include one, or more, of the following features, characteristics, operations and/or advantages: (i) combination of weather for three-dimensional space object location in near real time and in the future; (ii) change physical structure based on weather predictors, performance predictors and location predictors; (iii) forecast keys to the match and how we the stadium conditions to be pair players together based on weather predictors, performance predictors and location predictors (this should only be done in a responsible, and transparent, manner with due regard for the ethical conventions of the sport involved); (iv) quantifying previously unknown relationships between player outcomes, ball position and individual weather conditions; (v) leveraging player style analysis to extrapolate weather impacts on players of similar and differing playing styles; (vi) leveraging positional and velocity data to identify the impact of weather conditions on individual shot types; (vii) symbiosis between weather keys and an environment; (viii) symbiosis between weather keys and a mobile device; (ix) weather keys used for practice temporal scheduling; (x) weather keys used for practice place scheduling; and/or (xi) identifying the three (3) key performance objectives for each player.

Some embodiments of the present invention may include one, or more, of the following features, characteristics, operations and/or advantages: (i) quantifies the impact of certain weather conditions and combination of conditions on player styles and individual players; (ii) all the existing background references demonstrate alterations to predictions based on single point factors in weather (for example, an increase in humidity would lead to a 5% decrease in putting accuracy for an average player); (iii) fined-grained set of machine logic based rules; (iv) a novel set of techniques, a different process and entirely novel algorithms; (v) among the biggest differences are the use IoT (Internet of things) to change physical properties of the environment/stadium to change their opponents behavior and self; (vi) for example, the dome of the roof can be closed to increase temperature; and/or (vii) when creating a schedule or tournament bracket: (a) the use of information, (b) principal performance factors, and/or (c) the possible degrees of freedom of a stadium are taken into account so that rather than being seed/rank based the algorithm is now based on closeness of play.

Some embodiments of the present invention may include one, or more, of the following features, characteristics, operations and/or advantages: (i) produce a weather profile for each player within a match; (ii) determines a small, but measurable, relationship between play and the weather; (iii) create weather rules that say this player type performs well within context of weather; (iv) data source is from pre-existing data lake; (v) combine weather data with tennis match data; (vi) relate rules to weather impact on winning the match; (vii) historical data (30 years) is obtained through pre-existing data lake that has one, or more of the following features: (a) free, (b) not rate limited, (c) over 20,000 observation sites around the world, (d) regions have multiple sites (for example, a large city has 3 observation sites); (viii) real time weather information can come from a cloud platform as a service, (iv) weather data may be obtained from a cloud foundry app, (x) consistent weather data including temperature, pressure, humidity and heat index; (xi) inconsistent weather data including wind gusts and precipitation; and/or (xii) continually update predicting sporting event outcomes with updated current weather data applied to machine logic based rules.

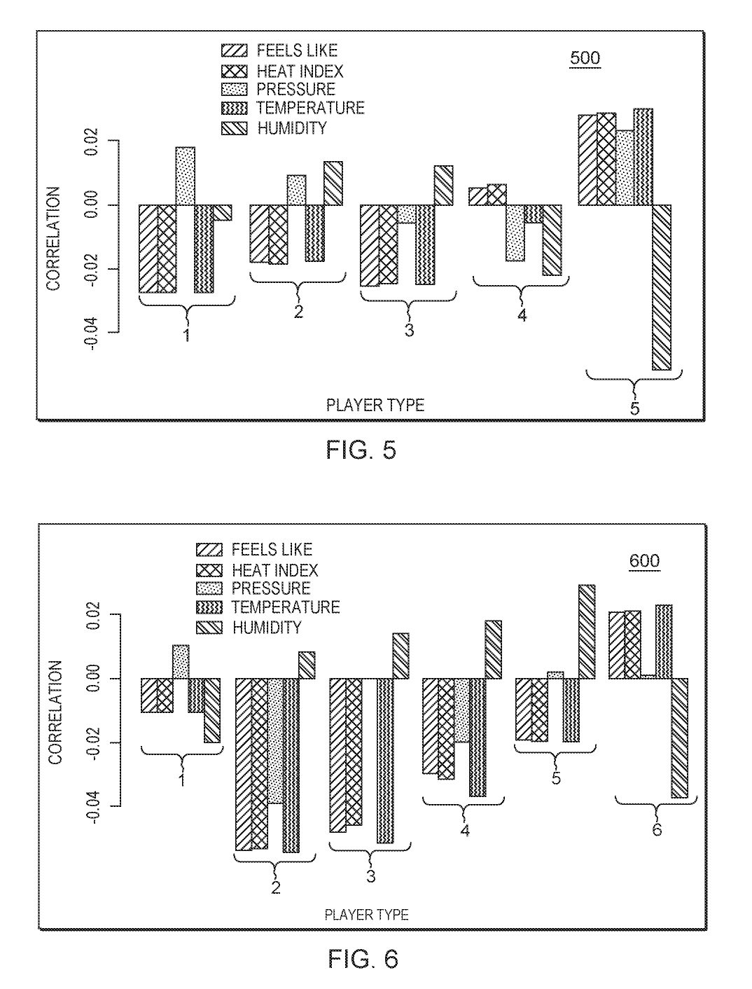

Impact of weather on play will now be discussed with reference to bar graph 500 of FIG. 5 and bar graph 600 of FIG. 6. Split data based on player type as follows: (i) six (6) player types (that is, styles of play) for women; and (ii) five (5) player types for men. Player types change based on the data—groups like players together. In tennis related embodiments, styles of play may include the following: counterpunchers, big-serve attackers, baseliners, aggressive baseliners, all-court players, net rushers, attackers, etc. Weather affects men and women tennis single players differently. Bar graph 500 shows weather effects on men's singles tennis play which is granular with respect to player's having different styles of play. Bar graph 600 shows weather effects on women's singles tennis play which is granular with respect to player's having different styles of play.

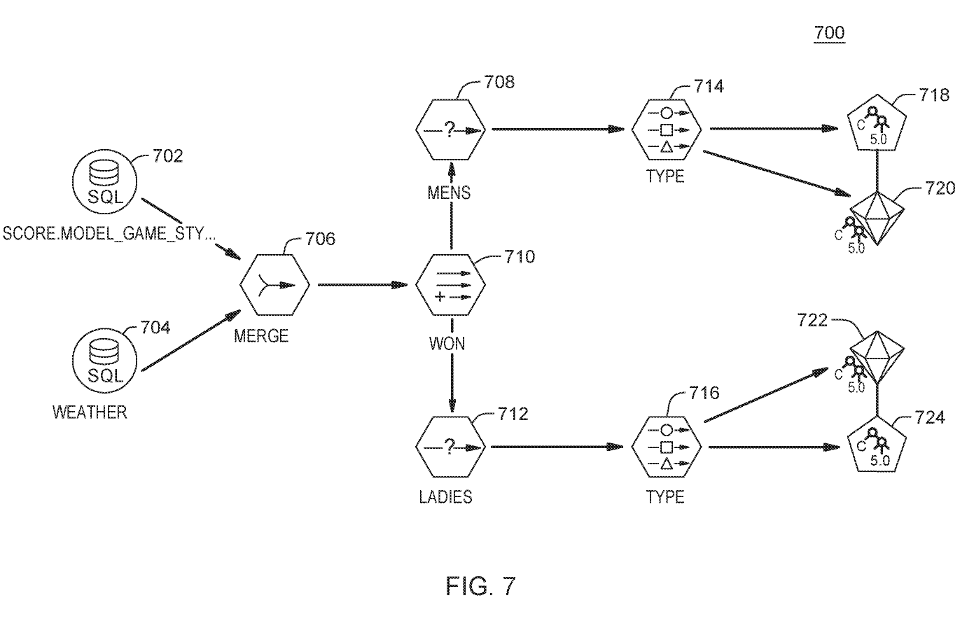

As shown in FIG. 7, generated rules are generated by a predictive analytics platform modeller stream. More specifically, as shown in diagram 700, the following blocks are involved in this generation of rules: historical contest outcome database 702; historical weather database 704; merge operation block 706; mens block 708; won block 710; ladies block 712; mens branch type block 714; ladies branch type block 716; mens branch tree block 718; mens branch generated rule block 720; ladies branch generated rule block 722; and ladies branch tree block 724.

Generated rules in an embodiment of the invention will now be discussed. In this embodiment, men's player style two (2) cluster produced 17 rules, some of which are encoded as follows (note: similar rules can be generated for women's tennis contests):

Rule 1 for YES

| | |
|---|---|
| if | PRESSURE_AVG<=1010.820 |

| | |
|---|---|
| and | HUMIDITY-AVG>52.575 |
| and | HUMIDITY_AVG<=53.361 |
| then | YES |

Rule 2 for YES

| | |
|---|---|
| if | FEELS_LIKE_AVG>60.758 |

| | |
|---|---|
| and | PRESSURE_AVG>1022.380 |
| and | PRESSURE_AVG<=1023.490 |
| and | HUMIDITY_AVG>52.575 |
| then | YES |

Rule 4 for YES

| | |
|---|---|
| if | FEELS_LIKE_AVG>67.296 |

| | |
|---|---|
| and | PRESSURE_AVG,<=1003.010 |
| and | TEMP_AVG<=67.470 |
| and | HUMIDITY_AVG>52.284 |
| then | YES |

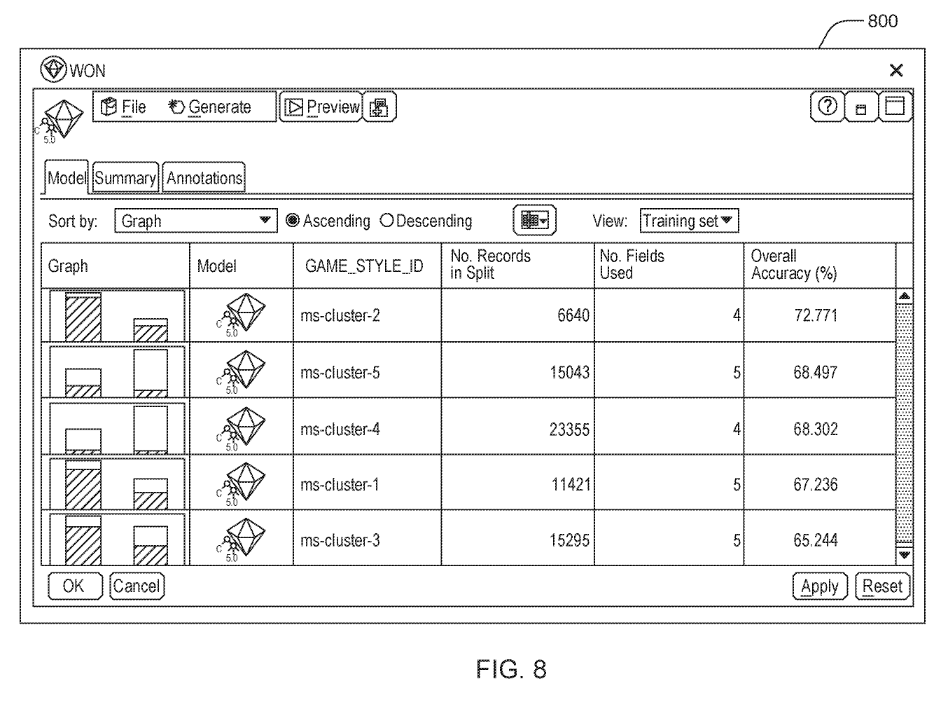

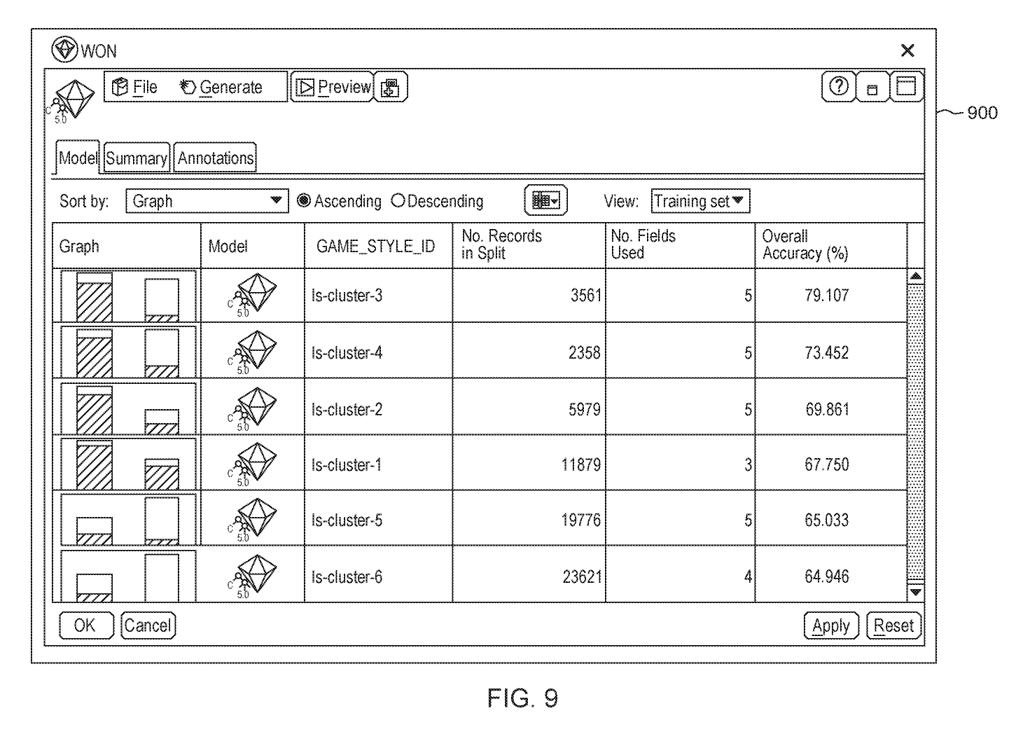

As shown in screenshot 800 of FIG. 8, in some embodiments, generated rules lead to models for each men's player type. As shown in screenshot 900 of FIG. 9, in some embodiments, generated rules lead to models for each women's player type. In this embodiment, it should be noted that the genders are broken down and subject to different sets of generated rules because it has been determined that a different framework of styles is helpful in characterizing women's tennis play as opposed to men's tennis play. For example, this embodiment is based on an assumption serve styles are often an important way of characterizing mens' tennis (or, more specifically, mens' tennis play as it is impacted by weather), while women's play is not (meaning that the womens' play styles relate to play aspects other than serve related play aspects). Alternatively, there may be only a single set of weather/style related rules for an entire sport. As a further alternative, the sets of weather/style rules may be broken down into different kinds of category other than gender (for example, clay court rules versus grass court rules).

Some embodiments of the present invention may include one, or more, of the following features, characteristics, advantages and/or operations: (i) the player types are not static; (ii) players agglomerated together to increase data purity; (iii) the assignment of a player into a group can change from each training session; (iv) flexibility to learn from the data; (v) in some embodiments, a player is characterized by only one player style; (vi) a player's play style is agglomerative clustering (for example, Kohonen Nodes, 2-step, and k-means clustering); (vii) the use IoT to change physical properties of the environment/stadium to change their opponents behavior and self in order to help to train athletes (for example, IoT control tailored to train a given player to play better under weather conditions likely to be unfavorable for that given player); (viii) during training, the idea is find the trainee's weakness—it is the inverse of finding a player's strength; (ix) use of IoT to control training conditions forms a closed loop from the weather and play style outcome prediction system to IoT device to measuring the environment and player's performance which leads to online learning; (x) the online learning would further change the importance of each weather rule and its respective target; and/or (xi) the system adjusts over time as a player's body adjusts to the weather conditions.

An example that uses an embodiment of machine logic according to an embodiment of the present invention will now be discussed. Player A is high seed player and plays well on clay but average on grass. He also plays terrible during high heat. Player B is a low seed player and plays well on grass and average on clay. He plays well during high heat. A tennis tournament is on grass and is experiencing very high heat. An embodiment of the present invention determines and feeds weather and play style data into a logistic regression ranker. The weather factors and play factors are combined to yield a new closeness of play rank. Player A is “closeness” ranked 12 and Player B is “closeness” ranked 11. As such, the two will play against each other.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

Sporting outcomes: includes, but is not necessarily limited, winning games, losing games, games played to a draw, number of points awarded by judges (for example, points in boxing), scoring, being scored against, penalty statistics, game specific statistics (for example, walks in baseball, service velocity in tennis), etc.

Sporting contests: any contest that involves significant competitively-directed physical activity between persons or teams of people; sporting contests include, but are not necessarily limited to, tennis matches, golf games, auto racing, bicycle racing, fishing derbies, skiing races, American style football games, English style football matches, curling competitions, badminton, arm wrestling competitions, boxing, fencing, basketball games, hockey games, swimming races, figure skating competitions, track events, weightlifting competitions, rugby games, archery, horseshoes, rodeos, racquetball, field hockey, martial arts competitions, capture the flag games, cricket, etc.; while sporting contests played outdoors are generally more likely to be beneficially impacted by various embodiments of the present invention, some embodiments of the present invention may have application to sporting contests played in enclosed or semi-enclosed spaces so long as some form of weather (see definition) is present.

Weather: includes, but is not necessarily limited to, the following: actual temperature, “feels like” temperature, heat index, wind chill factor, wind speed, wind direction, barometric pressure, humidity, rain, fog, snow fall, snow depth, snow texture, wave height and/or frequency, dew, pollution levels, pollen levels, moistness/wetness of terrain, and air ion index; while most weather is characteristic of the outdoors, “weather” as that term is hereby defined, may include characteristics that exist in indoor spaces such as sports stadiums; “weather,” as that term is hereby defined includes artificial weather (for example, artificial snow on ski slopes); weather caused by nature will herein be more specifically referred to as “natural weather.”

Play styles: characterizations of contest play that may relate to aspects of play including, but not limited to, the following: offensive play (that is, offense oriented actions taken by the player in participating in the substantive portion of the sporting contest), defensive play, overall play, peripheral play (for example, styles of deciding which option to choose upon a football penalty, styles of deciding whether to serve or receive first upon winning a coin toss at the beginning of a tennis sporting contest); in some embodiments, a player (see definition) may be characterized by more than one play style.

Player: may be an individual natural person, a team (for example, a doubles tennis team) taken collectively, an individual natural person working co-operatively with a coach or manager, or a team working co-operatively with a coach or manager.

Sports contests scheduling: may include one, or more of the following aspects: determining the identity of players or teams to play each other in a future sporting contest, determining when a future sporting contest will take place, determining geographic location for a future sporting contest and/or determining a venue (within a predetermined geographic area) for a future sporting contest.

What is claimed is:

1. A computer-implemented method comprising:
receiving a set of machine logic based rules that are programmed to predict outcomes of sporting contests based, at least in part, upon both of the following factors: weather of the sporting contests and play styles of players of the sporting contests;
receiving a first sporting contest data set including information related to a first sporting contest including: play styles of players that are playing, or proposed to play, in the first sporting contest and weather occurring, or forecasted for, the first sporting contest;
applying the set of machine logic rules to the first sporting contest data set to obtain a first predicted outcome; and
controlling a play condition of the first sporting contest based, at least in part, upon the first predicted outcome.

2. The method of claim 1 wherein the first sporting contest is a tennis match.

3. The method of claim 1 further comprising:
adjusting a position of a stadium roof automatically though the Internet of Things based, at least in part, upon the first predicted outcome.

4. The method of claim 1 wherein the first predicted outcome is a prediction of which player will win the first sporting contest.

5. The method of claim 1 wherein:
the weather data is data indicating weather actually occurring during play of the first sporting contest; and
the controlling of the play condition occurs during play of the first sporting contest.

6. A computer-implemented method comprising:
receiving a set of machine logic based rules that are programmed to schedule sporting contests based, at least in part, upon both of the following factors: weather of a set of to-e-scheduled sporting contests and play styles of players of the set of to-be-scheduled sporting contests;
receiving a first sporting contest data set including information related to the set of to-be-scheduled sporting contest including: play styles of players that are proposed to play in the set of proposed sporting contests and weather forecasted for time period and potential locations at which the set of proposed sporting contests may occur;
applying the set of machine logic rules to potential sporting contests in accordance with the set of to-be-scheduled sporting contests; and
scheduling the to-be-scheduled sporting contests to generate a set of scheduled contests, with the scheduling determining at least identities of the players to play in the scheduled contests.

7. The method of claim 6 wherein the scheduled contests are tennis matches.

8. The method of claim 6 wherein with the scheduling further determines locations for the scheduled contests.

9. The method of claim 6 wherein the scheduled contests are determined so that the scheduled contests are as evenly matched as possible in predicted outcomes based, at least in part, upon expected weather and play styles.

10. The method of claim 6 wherein:
the set of to-be-scheduled contests are training matches for the players.

11. A computer-implemented method comprising:
agglomerating players together to increase data purity;
receiving historical data related to historical sporting contest outcomes, play styles of players involved in the historical sporting contests and weather in which the historical sporting contests were conducted; and
generating, by machine logic and based upon the historical data, a set of machine logic rules, programmed to predict outcomes of sporting contests based, at least in part, upon both of the following factors: weather of the sporting contests and play styles of players of the sporting contests.

12. The method of claim 11 further comprising:
receiving new data related to a new sporting contest outcome, play styles of players involved in the new sporting contest and weather in which the new sporting contest was conducted; and
performing machine learning to adjust, by machine logic and based upon the new data, the set of machine logic rules.

13. The method of claim 12 further comprising:
determining a player's play style based upon agglomerative clustering.

14. The method of claim 13 wherein the agglomerative clustering uses Kohonen Nodes.

15. The method of claim 13 wherein the agglomerative clustering uses 2-step clustering.

16. The method of claim 13 wherein the agglomerative clustering uses k-means clustering.
